(19) United States
(12) Patent Application Publication
(10) Pub. No.: US 2005/0036640 A1
(43) Pub. Date: Feb. 17, 2005

(54) Small-size accessory with audio recording and playback device and transparent wall for holding and viewing an article

(76) Inventor: Larry Goldenberg, New York, NY (US)

Correspondence Address: GORDON & JACOBSON, P.C., 65 WOODS END ROAD, STAMFORD, CT, 06905, US

(21) Appl. No.: 10/638,618

(22) Filed: Aug. 11, 2003

(51) Int. Cl. H04R 1/02; H04R 9/06; G06F 17/00

(52) U.S. Cl. 381/334; 700/94; 704/272

(57) ABSTRACT

An apparatus having a body with a front surface opposite a back surface. The body is preferably no larger than a credit card size. An audio device, integral to the body, includes a speaker, memory capable of storing at least one audio message, at least one button adapted to initiate playback of an audio message, and possibly record functionality. A transparent wall is disposed on the back major surface of the body. An article is held in place between the transparent wall and the back major surface. The button and the speaker of the audio device are disposed on the front major surface. Preferably, portions of the apparatus are substantially opaque to hide the article when viewed from the front. The audio messages and visual indicia conveyed by the apparatus may be multimedia advertising, branding, and promotional information. The apparatus has applications has a multimedia souvenir, toy, and keychain accessory.

### BACKGROUND OF THE INVENTION

1. Field of the Invention

This invention relates broadly to small-size accessories that can be held by the human hand. More particularly, this invention relates to such small-size accessories incorporating an audio recording and playback device along with means for holding and viewing an article.

2. State of the Art

Small-sized audio recording and playback devices are well known. For example, U.S. Pat. No. 6,028,752 to Chomette et al., herein incorporated by reference in its entirety, describes an exemplary credit-card-sized audio recording and playback device that utilizes a piezoelectric component as a combination microphone/loudspeaker.

Small-sized audio recording and playback devices have been incorporated into a picture frame or plaque. For example, U.S. Pat. No. 5,359,374 discloses a picture frame with an audio recording and playback device mounted to the thick edge provided by the frame. The edge of the frame is made sufficiently thick to include the audio recording and playback device so that this device does not obscure the view of the picture mounted in the frame, and thus is unsuitable for small-sized applications.

In U.S. Pat. No. 5,841,878, a small-sized audio recording and playback device is incorporated into a hand-held holder of card-like articles. In this system, the article is housed within an optically clear enclosed portion of the top surface of the article (or applied directly to the top surface of the article). The speaker, microphone and controls of the audio recording and playback device are disposed around the periphery of the top surface of the article, which provides a limited area for holding and viewing the article.

Thus, there remains a need in the art for improved small-sized accessories that incorporate an audio recording and playback device along with means for holding and viewing an article in a manner that maximizes the area for holding and viewing an article, such as a photograph, card or the like.

In U.S. Pat. No. 6,041,532, an article (bottle opener, lighter, ball point pen) is configured to replay an audio advertisement upon activation of a tripping component. The audio advertisement is provided by a chip that is capable of storing speech signals in analog form. The tripping component is activated during normal operation of the article (e.g., when opening a bottle with the bottle opener, or when actuating the lighter or ball point pen). This article is capable of conveying only audio information, and thus is unsuitable for applications in which it is desirous to convey visual advertisements or other visual brand information. In addition, the audio advertisement provided by the chip cannot be readily updated by the user.

Thus, there remains a need in the art for an improved article that is capable of conveying audio advertisements (as well as other audio information) in addition to visual advertisements and/or visual branding information and/or visual promotional information associated with the audio information, and that preferably operates in a manner that enables a user to readily record, update and store audio information therein.

### SUMMARY OF THE INVENTION

It is therefore an object of the invention to provide a small-size accessory that incorporates an integral audio recording and playback mechanism along with means for holding and viewing an article in a manner that maximizes the area for holding and viewing the article.

It is another object of the invention to provide such a small-size accessory having an integral audio recording and playback mechanism that can store and playback several audio messages.

In accord with these objects, which will be discussed in detail below, a small-size accessory includes a body with a front major surface opposite a back major surface. The body is preferably no larger than a credit card size. An audio device is integral to the body. The audio device includes a speaker, at least one memory capable of storing at least one audio message, and at least one play-back button adapted to initiate playback of a corresponding audio message through the speaker. A transparent and flexible wall, which is preferably realized by a panel pocket, is disposed on the back major surface of the body. An article, such as a photograph, card or the like, is held in place between the transparent wall and the back major surface for viewing by the user of the accessory. The play-back button(s) and the speaker of the audio device are disposed on the front major surface of the body. Preferably, the audio device also has record functionality that includes a microphone and record button disposed on the front major surface of the body. Preferably, portions of the apparatus are substantially opaque such that the article, when inserted into the panel pocket, remains hidden when viewed from the front major surface of the body. The audio messages and visual indicia conveyed by the apparatus may be used to carry multimedia advertising information and multimedia branding information. The apparatus has applications as a keychain accessory that carries multimedia information.

According to one embodiment of the invention, the panel pocket includes two thin sheets of flexible material that are affixed to one another along their edges such that an opening remains for the insertion of the article.

According to another embodiment of the present invention, the panel pocket includes a transparent flexible sheet affixed to the back major surface of the body such that an opening remains for the insertion of the article.

According to another embodiment of the present invention, the panel pocket is omitted, and the accessory is used to convey multimedia information for advertising/branding/promotional purposes or to realize a multimedia souvenir or multimedia toy.

Additional objects and advantages of the invention will become apparent to those skilled in the art upon reference to the detailed description taken in conjunction with the provided figures.

### BRIEF DESCRIPTION OF THE DRAWINGS

FIGS. 1A and 1B are front and back schematic views of a first embodiment of a credit-card-sized accessory according to the present invention, including an audio record/playback mechanism integral to the accessory along with a flexible transparent wall (indicated by a set of broken lines) that holds an article and enables a user to view the article therethrough;

FIG. 2 is a schematic of a second embodiment of a credit-card-sized accessory according to the present invention; and

FIG. 3 is a schematic of a third embodiment of a credit-card-sized accessory according to the present invention.

FIG. 4 is a schematic of a fourth embodiment of a credit-card-sized accessory according to the present invention.

### DETAILED DESCRIPTION OF THE PREFERRED EMBODIMENTS

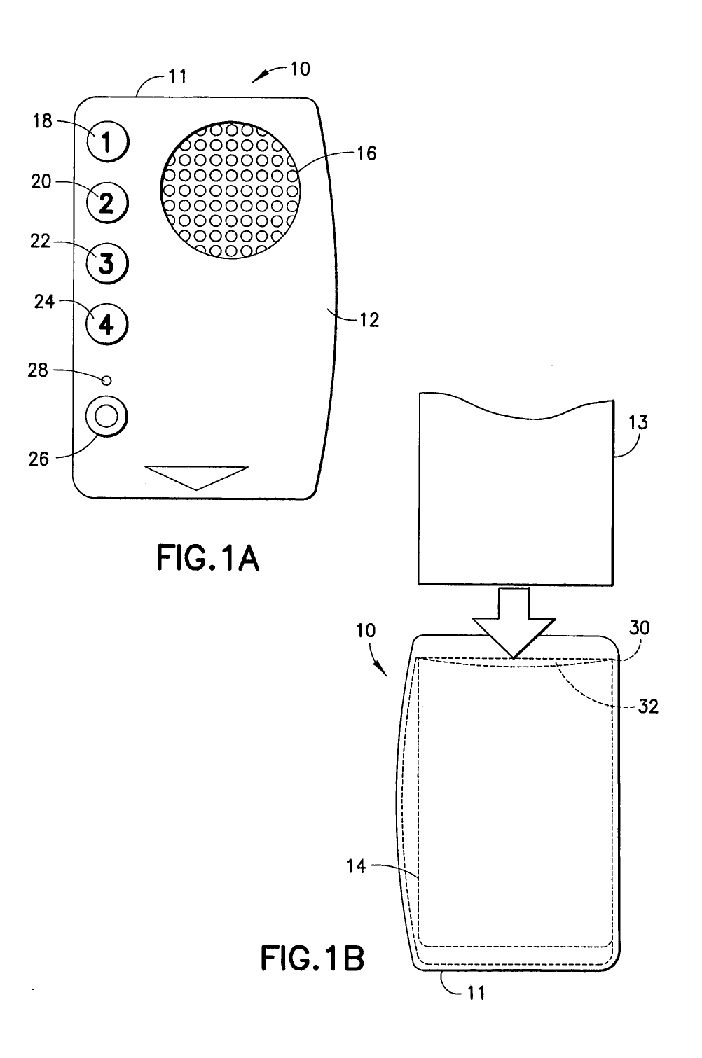

Turning now to FIGS. 1A and 1B, a small-sized accessory 10 is shown. The small-sized accessory 10 includes a body 11 with opposed substantially-planar major surfaces (i.e., a front surface 12 opposite a back surface 14). In the illustrative embodiment, the body 11 is generally the shape and size of a credit card (e.g., 2″×3″), although it may be slightly thicker (e.g., 3/32″−3/16″). An audio record and playback mechanism is integral to body 11. The audio record and playback mechanism includes a power source (e.g., battery, not shown), a microphone and an audio speaker (not shown), which may be realized by a dual-function microphone/speaker disposed behind a grill 16 as shown), a memory (not shown) for storing audio data such as recorded audio messages, buttons 18, 20, 22, 24 operating playback functions and button 26 operating record functions, and an LED indicator 28.

An exemplary credit-card-sized audio recording and playback mechanism is described in U.S. Pat. No. 6,028,752 to Chomette et. al, incorporated by reference above in its entirety. As one of several distinctions from the Chomette device, the audio recording and playback mechanism of accessory 10 preferably includes a plurality of playback buttons 18, 20, 22, 24 each having different visual indicia associated therewith. For example, button 18 has a ‘1’ thereon, button 20 has a ‘2’ thereon, button 22 has a ‘3’ thereon, and button 24 has ‘4’ thereon.

The accessory 10, by way of example, may be operated to record an audio message for storage in memory by pressing the record button 26 in conjunction with any one of the playback button 18, 20, 22, 24. During recording, the LED indicator 28 lights up, and sound, e.g. voice, is directed by the user toward the microphone grille 16. Recording is terminated and the message is saved upon release of the record button 26 or when the memory allocated for that message is full, whichever occurs first. Each message preferably may be up to fifteen seconds in length. The recorded message may thereafter be played back by pressing the corresponding playback button only.

As shown in FIG. 1A, the playback buttons 18, 20, 22, 24, the record button 28, the LED 28, the speaker (and preferably the microphone) are all disposed on the front side 12 of the body 11.

As shown in FIG. 1B, a panel pocket 30 is formed on the back side 14 (opposite major surface) of the body 11. A photograph, card or other article 13 may be placed within the panel pocket 30. The outside wall 32 of the panel pocket 30 is formed from a flexible and transparent material, such as a thin sheet of transparent plastic made from acrylic, polyvinyl or other transparent plastic. The flexible, transparent wall 32 enables the user to view the article 13 placed within the panel pocket 30, while protecting the article 13 from damage while handling the accessory 10.

In one embodiment, the panel pocket 30 is formed by two thin sheets (an inner wall and an outer wall) of flexible material that are affixed to one another (e.g., utilizing a heat seal, bonding or stitching) along their edges (leaving an opening for the insertion of the article 13), and then adhering the inner wall of the panel pocket 30 to the back side 14 of the body 11 utilizing a suitable adhesive. In this embodiment, the outer wall of the panel pocket 30 (and possibly the inner wall) is transparent, which enables the user to view the article 13 through the outer wall when inserted therein.

In another embodiment, the panel pocket 30 is formed by affixing the edge(s) of a transparent flexible sheet (preferably formed from a transparent plastic such as acrylic, polyvinyl) to the back side 14 of the body 11 (e.g., utilizing a heat seal, bonding) while leaving an opening 32 for the insertion of the article 13.

In yet another embodiment, the article 13 is fixably disposed behind a transparent flexible sheet by affixing the edge(s) of a transparent flexible sheet (preferably formed from a transparent plastic such as acrylic, polyvinyl) to the back side 14 of the body 11 (e.g., utilizing a heat seal, bonding) while the article 13 is disposed between the transparent flexible sheet and the back side 14 of the body 11 such that the article is laminated to the body.

Preferably, the body 11 (or portions thereof) of the accessory 10 (or portions of the panel pocket 30) are substantially opaque such that the article 13, when inserted into the panel pocket 30, remains hidden when viewed from the front side 12 of the body 11. This feature may be accomplished by forming the body 11, or by forming the inner wall of the panel pocket 30 from an opaque material. Alternatively, an opaque coating may be applied to the front surface 12 and/or the back surface 14 such that the article 13, when inserted into the panel pocket 30, remains hidden when viewed from the front side 12.

With the small-sized accessory of the present invention, it will be appreciated that a user of the accessory will have the opportunity to insert an article into the panel pocket and record a voice message(s) associated with that article by manipulating the audio record/playback mechanism integral to the accessory. The user (or a subsequent user) can view the article contained in the panel pocket and listen to the recorded voice message(s) associated with that article by manipulating the audio record/playback mechanism integral to the accessory. The small size of the accessory enables it to be carried and used ubiquitously.

Advantageously, the small-sized accessory of FIGS. 1A and 1B incorporate the controls and speaker of the audio record and playback mechanism on one side of the body while the pocket panel used to hold and view an article is disposed on the opposite side of the body. In this manner, the accessory 10 provides a large unobstructed view area for articles held therein and ease of operation.

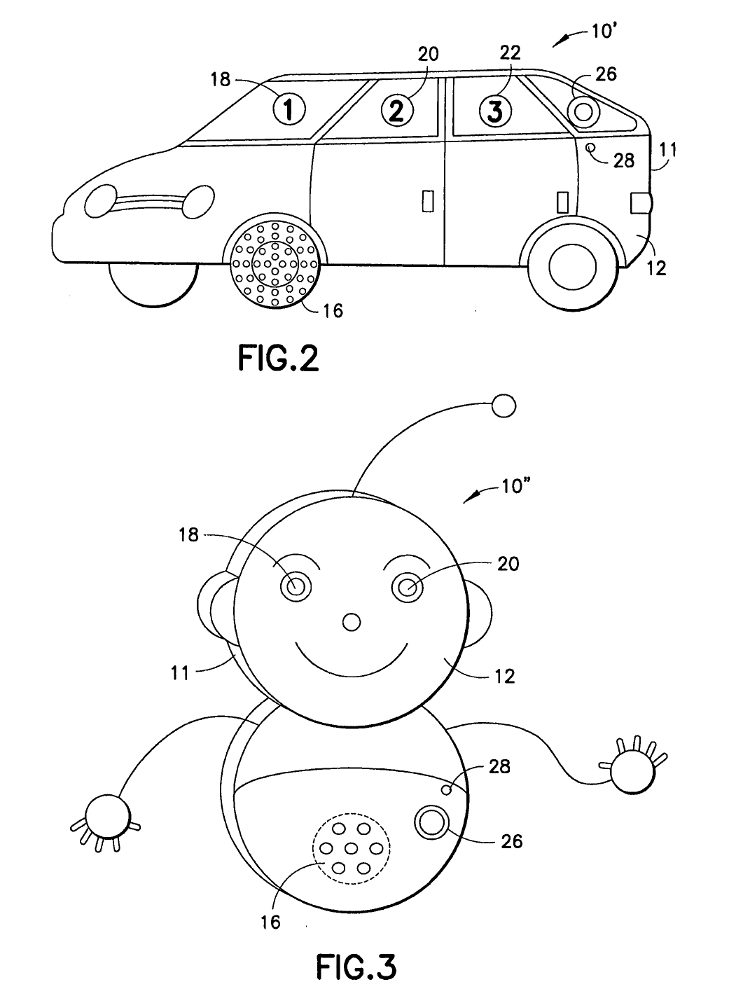

In an alternate embodiment as shown in FIG. 2, the small-sized accessory as described above may be adapted to convey audio advertisements (as well as other audio information) in addition to corresponding visual advertisements and/or branding information and/or promotional information. In the illustrative embodiment shown in FIG. 2, the general shape of body 11 of the accessory 10′ (and the artwork printed on the front surface 12 of the body 11) corresponds to a specific model of automobile. The playback buttons 18, 20, 22 provide audio messages/advertisements related to the specific model of automobile. For example, the messages may provide information as to features incorporated into the automobile, specifications of the automobile, pricing information and/or financing information for the automobile, etc. In this configuration, one or more of the play-back buttons 18, 20, 22, are preferably associated with unalterable audio messages to ensure that such audio message(s) reach the user. However, it is contemplated that one or more of the play-back buttons 18, 20, 22 may be associated with alterable audio messages recorded by the user (or other user) of the accessory as described above. The feature provides a keepsake with continued utility and lengthens the ‘life’ of the audiovisual advertisements conveyed by the article.

Note that the shape and visual indicia of the article 10′ may be readily adapted to provide advertisements and branding and promotional material for other types of products or services. Alternatively, the shape and visual indicia of the article may be readily adapted to realize a multimedia souvenir or multimedia toy. For example, the general shape and visual indicia of the accessory may have a likeness to one or more television characters (e.g., Big Bird of Sesame Street®), movie characters or other well know characters. An example of such an article 10″ is shown in FIG. 3. In this configuration, the play-back buttons 18, 20 are associated with audio messages (which may be alterable or unalterable by the user) that relate to the character visually depicted by the accessory 10″.

In alternate embodiments not shown, visual indicia alone (and not the shape of the body 11) may be used to convey visual information (e.g., advertisements, branding information, promotional information, one or more characters).

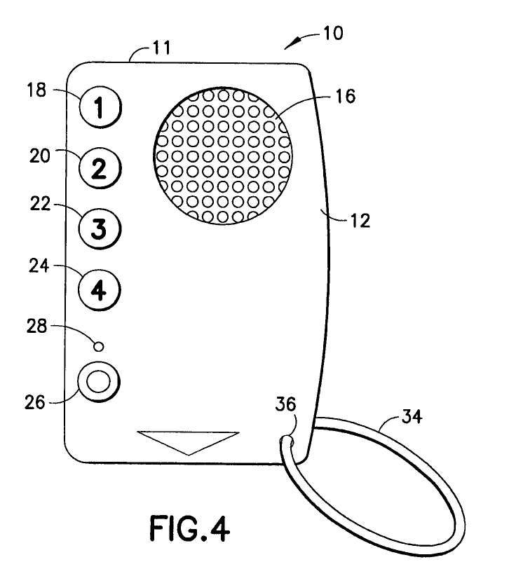

As shown in FIG. 4, the small-sized accessory as described herein may incorporate a keychain attachment 34 that enables one or more keys to be coupled to the accessory 10. Preferably, the keychain attachment 34 is coupled to the body 11 via a hole 36 through the body 11 as shown. In this configuration, the panel pocket disposed on the back side of the accessory may be omitted. This may be suitable for advertising applications as described above with respect to FIG. 2.

There have been described and illustrated herein embodiments of a small-sized accessory having an audio record/playback mechanism integral to the accessory along with a flexible transparent pocket panel that holds an article and enables a user to view the article therethrough. While particular embodiments of the invention have been described, it is not intended that the invention be limited thereto, as it is intended that the invention be as broad in scope as the art will allow and that the specification be read likewise. Thus, while an audio device having recording and playback capabilities is described, the audio device might having playback capability only, and audio storage may be obtained from a download via a data port (not shown). In addition, the device may additionally or alternatively have video capability for playback of video files, where the video files are placed in device memory by a recording system of the device and/or via download. Also, while the small-sized accessory is shown as having a single pocket panel, it will be appreciated that the accessory may include multiple pocket-panels. In addition, while the preferred embodiments of the accessory as described above are the size and shape of a credit card, it will be appreciated the it can be smaller (or larger) than a credit card and have any arbitrary substantially-planar shape. It will therefore be appreciated by those skilled in the art that yet other modifications could be made to the provided invention without deviating from its spirit and scope as claimed.

1. An apparatus comprising:
a body including a front major surface opposite a back major surface, each of which is substantially planar;
an audio device integral to said body, said audio device including a speaker, at least one memory capable of storing at least one audio message, and at least one button adapted to initiate playback of a corresponding audio message through said speaker;
a transparent wall for holding and viewing an article disposed between said wall and said back major surface of said body;
wherein said transparent wall is disposed on said back major surface, and said at least one button and said speaker are disposed on said front major surface.

2. The apparatus according to claim 1, wherein:
said audio device includes a plurality of play-back buttons that are adapted to initiate playback of different audio messages through said speaker, wherein said plurality of play-back buttons are disposed on said front major surface.

3. The apparatus according to claim 2, wherein:
at least one of said audio messages is unalterable by the user.

4. The apparatus according to claim 2, wherein:
said plurality of play-back buttons each have different visual indicia associated therewith.

5. The apparatus according to claim 1, wherein:
said audio device includes recording functionality and a microphone.

6. The apparatus according to claim 5, wherein:
said audio device includes a record button that is adapted to initiate recording of audio messages input through said microphone, wherein said record button and said microphone are disposed on said front major surface.

7. The apparatus according to claim 6, wherein:
said audio device includes a visual indicator that is active during recording of audio messages input through said microphone.

8. The apparatus according to claim 1, wherein:
said transparent wall is flexible.

9. The apparatus according to claim 8, wherein:
said transparent wall is realized by a panel pocket including two thin sheets of flexible material that are affixed to one another along their edges such that an opening remains for the insertion of the article.

10. The apparatus according to claim 8, wherein:
said transparent wall is realized by a panel pocket including a transparent flexible sheet affixed to said back major surface of said body such that an opening remains for the insertion of the article.

11. The apparatus according to claim 8, wherein:
said transparent wall is realized by a transparent flexible sheet whose edges are affixed to said back major surface of said body while said article is disposed between said transparent wall and said back major surface of said body.

12. The apparatus according to claim 1, further comprising:
visual indicia associated with said at least one audio message.

13. The apparatus according to claim 12, wherein:
said visual indicia includes at least one of the shape of said body and visual information affixed to the front major surface of said body.

14. The apparatus according to claim 12, wherein:
said visual indicia conveys at least one of advertising information, brand information, and promotional information.

15. The apparatus according to claim 12, wherein:
said visual indicia conveys a likeness of one or more characters.

16. The apparatus according to claim 1, wherein:
portions of said apparatus are substantially opaque such that the article, when disposed between said wall and said back major surface, remains hidden when viewed from said front major surface of the body.

17. The apparatus according to claim 16, wherein:
a portion of said body is substantially opaque.

18. The apparatus according to claim 17, wherein:
said portion of said body is formed from a substantially-opaque material.

19. The apparatus according to claim 17, wherein:
said portion of said body is coated with a substantially-opaque film.

20. The apparatus according to claim 1, wherein:
said body is not substantially larger than a credit card size.

21. An apparatus comprising:
a body including a front major surface opposite a back major surface, each of which is substantially planar;
an audio device integral to said body, said audio device including a speaker, at least one memory capable of storing at least one audio message, and at least one button adapted to initiate playback of a corresponding audio message through said speaker;
visual indicia associated with said at least one audio message; and
a keychain attachment operably coupled to said body.

22. An apparatus according to claim 21, wherein:
said body is not substantially larger than a credit card size.

23. The apparatus according to claim 21, wherein:
said visual indicia includes at least one of the shape of said body and visual information affixed to the front surface of said body.

24. The apparatus according to claim 23, wherein:
said visual indicia conveys at least one of advertising information, brand information, and promotional information.

25. The apparatus according to claim 23, wherein:
said visual indicia conveys a likeness of one or more characters.

26. The apparatus according to claim 21, further comprising:
a transparent wall for holding and viewing an article between said transparent wall and said back major surface of said body.

27. The apparatus according to claim 26, wherein:
said transparent wall is flexible.

28. The apparatus according to claim 27, wherein:
said transparent wall is realized by a panel pocket including two thin sheets of flexible material that are affixed to one another along their edges such that an opening remains for the insertion of the article.

29. The apparatus according to claim 27, wherein:
said transparent wall is realized by a panel pocket including a transparent flexible sheet affixed to said back major surface of said body such that an opening remains for the insertion of the article.

30. The apparatus according to claim 27, wherein:
said transparent wall is realized by a transparent flexible sheet whose edges are affixed to said back major surface of said body while said article is disposed between said transparent wall and said back major surface of said body.

31. The apparatus according to claim 21, wherein:
said audio device includes a plurality of play-back buttons that are adapted to initiate playback of different audio messages through said speaker, wherein said plurality of play-back buttons are disposed on said front major surface.

32. The apparatus according to claim 31, wherein:
at least one of said audio messages is unalterable by the user.

33. The apparatus according to claim 31, wherein:
said plurality of play-back buttons each have different visual indicia associated therewith.

34. The apparatus according to claim 21, wherein:
said audio device includes recording functionality and a microphone.

35. The apparatus according to claim 34, wherein:
said audio device includes a record button that is adapted to initiate recording of audio messages input through said microphone, wherein said record button and said microphone are disposed on said front major surface.

36. The apparatus according to claim 34, wherein:
said audio device includes a visual indicator that is active during recording of audio messages input through said microphone.

37. An apparatus comprising:
a body including a front major surface opposite a back major surface, each of which is substantially planar;
an audio device integral to said body, said audio device including a speaker, at least one memory capable of storing at least one audio message, and at least one button adapted to initiate playback of a corresponding audio message through said speaker; and
visual indicia relating to said at least one audio message, said visual indicia including at least one of the shape of said body and visual information affixed to said front major surface of said body.

38. An apparatus according to claim 37, wherein:
said body is not substantially larger than a credit card size.

39. The apparatus according to claim 37, wherein:
said visual indicia conveys at least one of advertising information, brand information, and promotional information.

40. The apparatus according to claim 37, wherein:
said visual indicia conveys a likeness of one or more characters.

41. The apparatus according to claim 37, further comprising:
a transparent wall for holding and viewing an article between said transparent wall and said back major surface of said body.

42. The apparatus according to claim 41, wherein:
said transparent wall is flexible.

43. The apparatus according to claim 37, wherein:
said audio device includes a plurality of play-back buttons that are adapted to initiate playback of different audio messages through said speaker, wherein said plurality of play-back buttons are disposed on said front major surface.

44. The apparatus according to claim 43, wherein:
at least one of said audio messages is unalterable by the user.

45. The apparatus according to claim 43, wherein:
said plurality of play-back buttons each have different visual indicia associated therewith.

46. The apparatus according to claim 37, wherein:
said audio device includes recording functionality and a microphone.

47. The apparatus according to claim 46, wherein:
said audio device includes a record button that is adapted to initiate recording of audio messages input through said microphone, wherein said record button and said microphone are disposed on said front major surface.

48. The apparatus according to claim 46, wherein:
said audio device includes a visual indicator that is active during recording of audio messages input through said microphone.
